(19) United States
(12) Patent Application Publication
(10) Pub. No.: US 2010/0103260 A1
(43) Pub. Date: Apr. 29, 2010

(54) WIND TURBINE INSPECTION

(76) Inventor: SCOT I. WILLIAMS, ANSON, TX (US)

Correspondence Address: Klemchuk Kubasta LLP, 8150 N Central Expressway, SUITE 1150, DALLAS, TX, 75206, US

(21) Appl. No.: 12/606,737

(22) Filed: Oct. 27, 2009

Related U.S. Application Data
(60) Provisional application No. 61/108,590, filed on Oct. 27, 2008.

(51) Int. Cl. H04N 7/18; G06F 13/42

(52) U.S. Cl. 348/144; 340/825; 348/E07.085

(57) ABSTRACT

A method for inspecting wind turbines remotely using a remotely controlled vehicle capable of controlled flight with a camera amounted to the vehicle. The vehicle is positioned near the wind turbine and the camera captures images of the wind turbine for visual inspection.

### CLAIM OF PRIORITY

Applicant claims priority based on U.S. provisional patent application Ser. No. 61/108,590 filed Oct. 27, 2008, entitled “Wind Turbine Inspection Method,” the entire content of which is incorporated herein by reference.

### BACKGROUND

1. Field of the Invention

The present invention relates generally apparatus and methods for inspecting wind turbines and in particular to the use of a remote controlled flying vehicle to inspect wind turbines.

2. Description of Related Art

Wind turbines need to be inspected periodically to ensure the structural integrity of the blades and other structural elements. The failure of certain elements may cause extensive damage to the turbine as well as any surrounding structures.

Within the wind turbine industry, and in particular within the maintenance and service market, current means for inspecting wind turbines require the shutdown of the turbine for several days to set up an inspection crane, inspect the turbine, and then remove the inspection rig. Such inspections are expensive because of the time the turbine must be shut down and the cost of the equipment needed to reach very tall turbines.

All references cited herein are incorporated by reference to the maximum extent allowable by law. To the extent a reference may not be fully incorporated herein, it is incorporated by reference for background purposes and indicative of the knowledge of one of ordinary skill in the art.

### BRIEF SUMMARY OF THE INVENTION

The problems presented in the field of wind turbine inspection are addressed by the systems and methods of the present invention. In accordance with one embodiment of the present invention, a remotely operated flying vehicle with an onboard camera is provided. The vehicle may be flown near the structural elements of the wind turbine such that the elements and turbine as a whole may be inspected from a remote location. The camera may take video images, still images, high definition video images, high definition still images, infrared images, or low light images while being controlled from a remote location. The camera and the vehicle may be controlled by the same person or by separate operators.

Other objects, features, and advantages of the present invention will become apparent with reference to the drawings and detailed description that follow.

### BRIEF DESCRIPTION OF THE DRAWINGS

FIG. 1 is a view of a typical wind turbine;

FIG. 2A is a view of a typical wind turbine being inspected by a remotely operated flying vehicle;

FIG. 2B is a view of a typical wind turbine being inspected by a remotely operated flying vehicle being controlled by multiple operators;

FIG. 2C is a view of a typical wind turbine being inspected by a remotely operated vehicle being controlled by one operator in visual contact with the wind turbine and a second operator more removed from the wind turbine;

FIG. 3 is a close-up view of the wind turbine being inspected by the remotely operated vehicle;

FIG. 4A is a close up view of the remotely operated vehicle inspecting a first side of a wind turbine blade;

FIG. 4B is a close-up view of the remotely operated vehicle inspecting a second side of a wind turbine blade.

### DETAILED DESCRIPTION OF THE PREFERRED EMBODIMENT

All references cited herein are incorporated by reference to the maximum extent allowable by law. To the extent a reference may not be fully incorporated herein, it is incorporated by reference for background purposes and indicative of the knowledge of one of ordinary skill in the art.

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical mechanical and electrical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

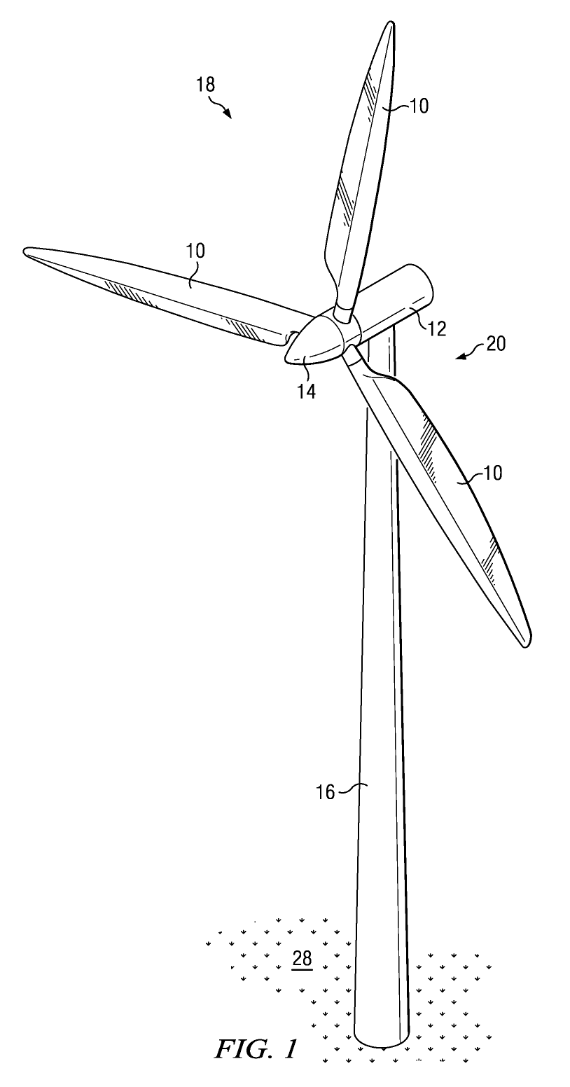

FIG. 1 is a view of a typical wind turbine 20, having a rotor 18 attached to a nacelle 12 atop a tower 16. The rotor 18 is made up of blades 10 attached to a hub 14 attached to a turbine (not shown) within the nacelle. Blades 10 have adjustable pitch which allows them to about their long axis to change the speed at which the rotor 18 rotates in a given wind. Tower 16 is shown mounted on the ground 28, but may be placed off-shore or may be located in a fresh water body of water, such as a lake or swamp land.

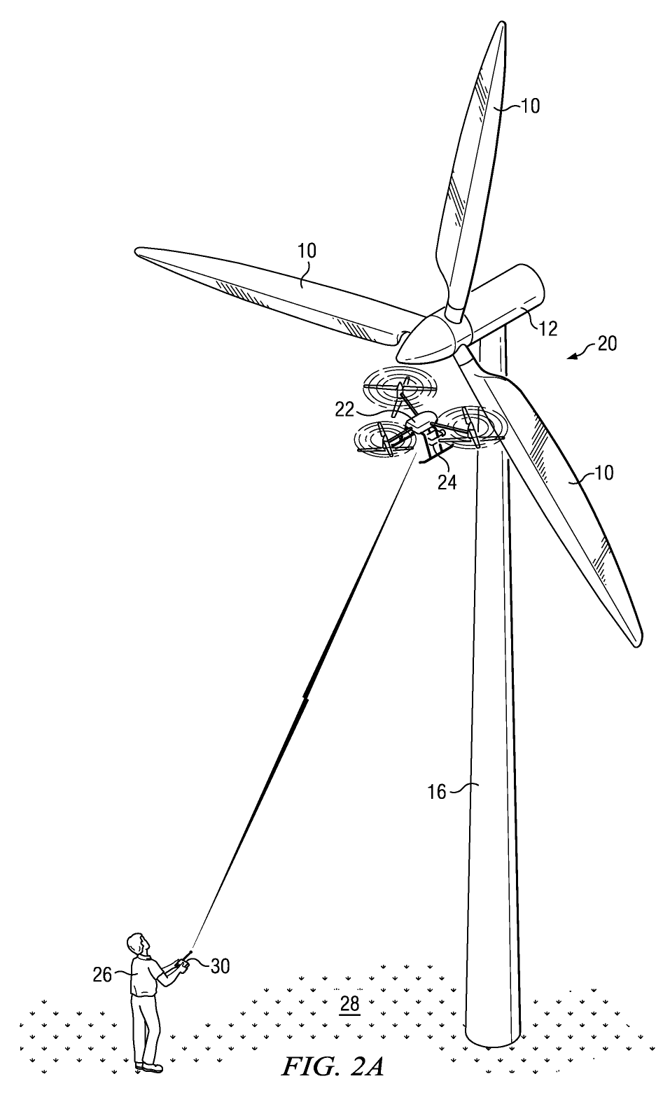

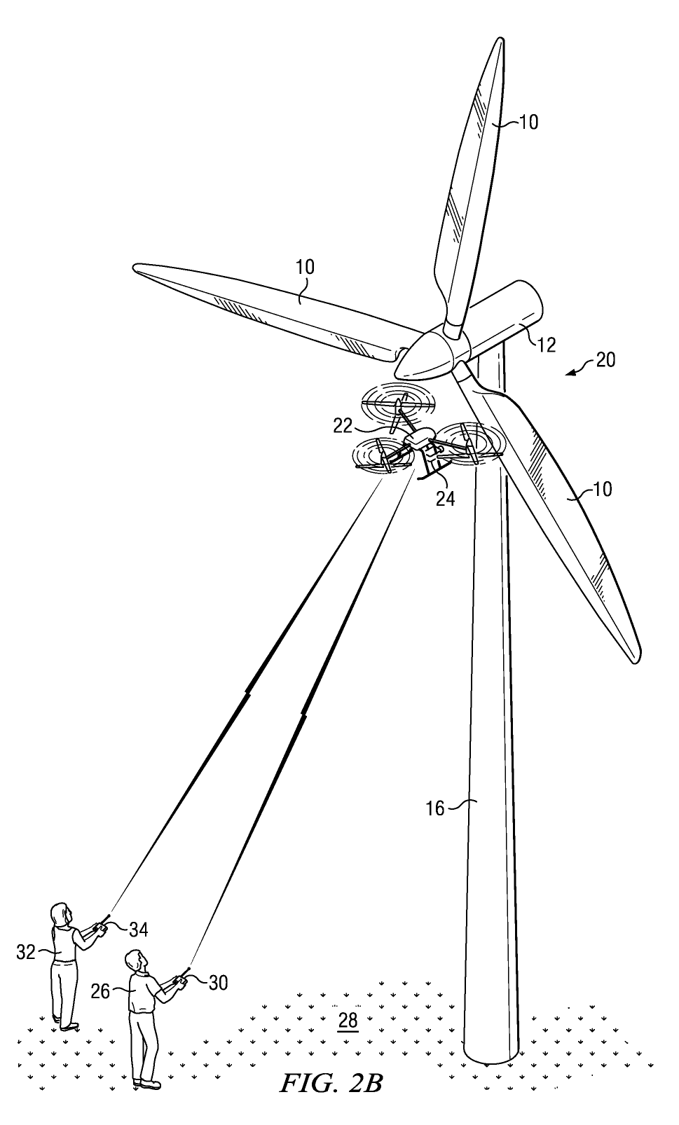

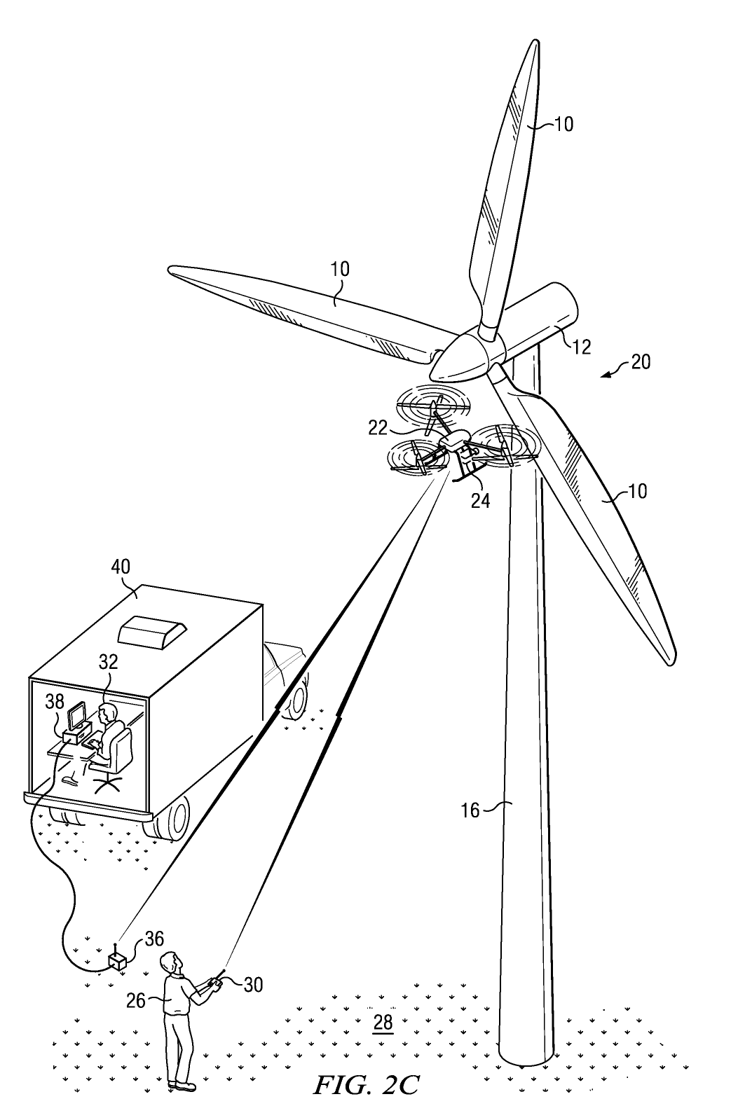

FIG. 2A is a view of a typical wind turbine 20 being inspected by a remotely operated flying vehicle 22 with a camera 24. The vehicle 22 is controlled by an operator 26 using a wireless hand held controller 30. The vehicle 22 shown is a type of helicopter known a the DRAGANFLYER X6 made by Draganfly Innovations, Inc. of Saskatoon, SK, Canada. Other remotely operated helicopters could be utilized as the vehicle 22. Camera 24 would be selected to provide the performance characteristics desired at the lowest reasonable weight to maximize the battery life and maneuverability of the vehicle 22. For example, a high resolution compact video camera such as the Panasonic HDC-SD9 may be used to capture high definition video inspections while a Panasonic DMC-FX500K may be used to capture high definition still photo inspections. Other cameras 24 may be used to achieve other image captures for inspection purposes such as infrared cameras, low light cameras, high speed cameras, and any other camera that may be useful for inspecting a wind turbine structure. The cameras 24 provide images that can be reviewed to provide a visual inspection of the wind turbine.

During an inspection as shown in FIG. 2A operator 26 can view the image being captured by camera 24 on the wireless hand held controller 30. This allows operator 26 to control the vehicle 22 and the camera 24 to inspect the wind turbine 20. One feature of the vehicle 22 is the ability to lock its position using GPS signals. The vehicle 22 may hover at a set longitude and latitude to allow the operator 26 to focus on operation of the camera 24. Once the coordinates are fixed the operator 26 can move the vehicle 22 vertically at the same coordinates to inspect a blade 10 or tower 16.

FIG. 2B is a view of a typical wind turbine 20 being inspected by a remotely operated flying vehicle 22 being controlled by multiple operators 26, 32. Typically, one operator 26 will be focused on operating the vehicle with respect to the turbine 20 while the second operator 32 may focus on operating the camera 24. By sharing the operational responsibility a more coordinated effort may be employed to make the most of the battery time available on the vehicle 22 while ensuring the safety of the vehicle 22 and the turbine 20. The second operator 32 will have a second hand held controller 34 and may have some control over the flight of the vehicle 22. For example the first operator 26 may position the vehicle and engage a GPS positional lock and then the second controller 32 may move the vehicle 22 vertically within that positional lock to capture the necessary inspection images with the camera 24.

FIG. 2C is a view of a typical wind turbine 20 being inspected by a remotely operated vehicle 22 being controlled by one operator 26 in visual contact with the wind turbine 20 and a second operator 32 more removed from the wind turbine 20. In this embodiment a base stations 36 is used to relay information from the vehicle 22 and camera 24 to a computer 38 remote from the wind turbine 20, such as in a van 40, where the second operator 32 may control the camera 24 and the vehicle 22. As in FIG. 2B the second operator 32 may be in control of just the camera 24, or the camera 24 and the vehicle 22 from the remote location. An advantage of this arrangement is that the second operator 32 will have a larger image showing what is being captured by the camera 24 allowing for more immediate feedback as to whether the inspection is sufficient or if more detail is required. Second operator 32 may also monitor the condition of the vehicle 22, such as power output, battery reserves and other information that may be communicated from the vehicle 22 to the base station 36. Van 40 may provide a base of operations for the vehicle 22 by providing spare parts and batteries making redeployment quicker. Base station 36 is in wireless communication with the vehicle 22 and camera 24 but may be attached to computer 38 via a wired or wireless connection.

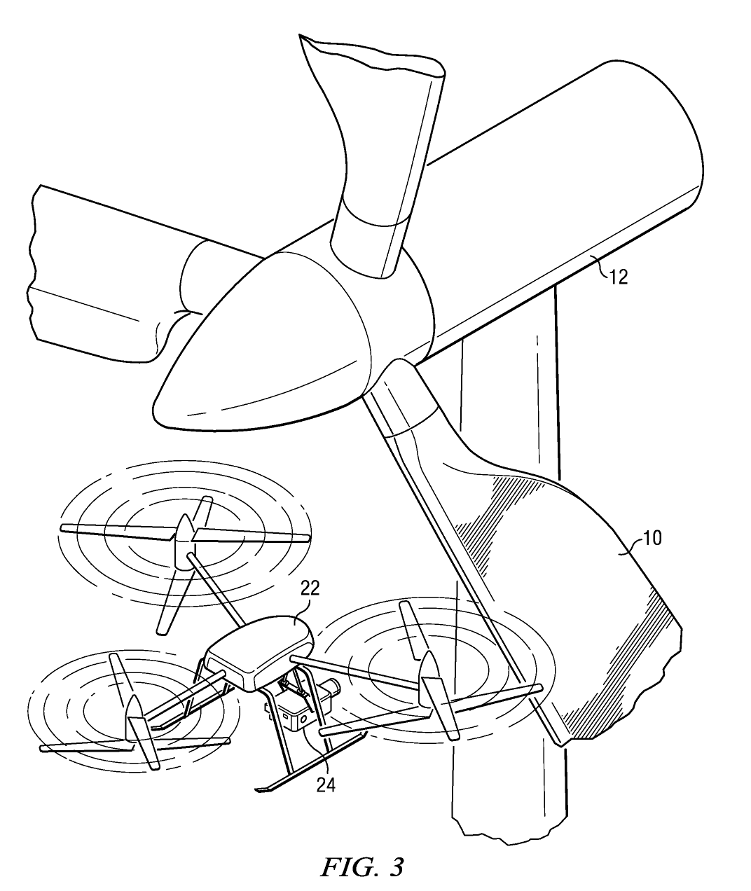

FIG. 3 is a close-up view of the wind turbine blade 10 being inspected by the remotely operated vehicle 22 with a camera 24. An agile aircraft is used as vehicle 22 to position the camera 24 as close as possible to blade 10 within reasonable limits. The vehicle 22 shown has three pairs of counter rotating rotors to provide a stable and maneuverable platform for the camera 24.

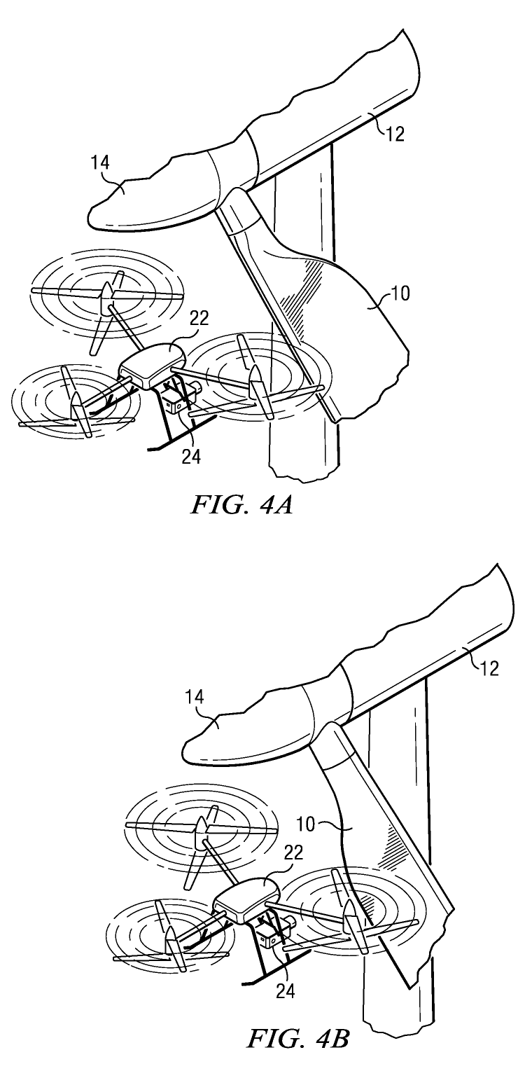

FIG. 4A is a close up view of the remotely operated vehicle 22 inspecting a first side of a wind turbine blade 10 while FIG. 4B is a close-up view of the remotely operated vehicle 22 inspecting a second side of a wind turbine blade 10. Because blade 10 has a variable pitch it may be rotated relative to hub 14 such that a first side is exposed and inspected as shown in FIG. 4A and then a second side may be exposed and inspected as shown in FIG. 4B. This method of inspecting a first side of a blade and then rotating the blade for inspection of the second side allows the vehicle 22 to inspect the blades from one side of the turbine 20 without having to get close the nacelle 12 during the inspection.

It should be apparent from the foregoing that an invention having significant advantages has been provided. While the invention is shown in only a few of its forms, it is not just limited but is susceptible to various changes and modifications without departing from the spirit thereof. For example, van 40 may be replaced by a boat to facilitate inspections of wind turbines 20 located over water instead of land 28.

I claim:

1. A method for inspecting a wind turbine comprising:
providing a remotely controlled vehicle;
providing a camera;
mounting the camera on the remotely controlled vehicle capable of controlled flight;
positioning the remotely controlled vehicle adjacent a wind turbine; and
capturing images with the camera of the wind turbine.

2. The method of claim 1 further comprising:
providing a first hand held controller;
using the hand held controller to control the position of the remotely controlled vehicle relative to the wind turbine; and
using the hand held controller to control the operation of the camera to capture images of the wind turbine.

3. The method of claim 1 further comprising:
providing a first hand held controller;
providing a second hand held controller;
using the first handheld controller to control the flight of the remotely controlled vehicle; and
using the second hand held controller to control the operation of the camera.

4. The method of claim 1 further comprising:
providing a first hand held controller;
providing a base station in wireless communication with the camera and a computer;
using the first handheld controller to control the flight of the vehicle;
using the computer to control the operation of the camera.

5. The method of claim 4 further comprising:
using the computer to monitor the remotely controlled vehicle and to control the flight of the remotely controlled vehicle.

6. The method of claim 1 further comprising:
reviewing the images captured by the camera to find defects in the wind turbine.

7. The method of claim 1 further comprising:
adjusting a pitch of a blade of the wind turbine to allow inspection of both sides of the blade.
